(19) United States
(12) Patent Application Publication
(10) Pub. No.: US 2012/0140236 A1
(43) Pub. Date: Jun. 7, 2012

(54) Spatial Spectral Photonic Receiver for Direction Finding via Wideband Phase Sensitive Spectral Mapping

(75) Inventors: William R. Babbitt, Bozeman, MT (US); Zeb Barber, Bozeman, MT (US); Calvin Harrington, Bozeman, MT (US); Kristian D. Merkel, Bozeman, MT (US); Krishna Mohan Rupavatharam, Bozeman, MT (US); Charles W. Thiel, Bozeman, MT (US)

(73) Assignees: S2 CORPORATION, Bozeman, MT (US); MONTANA STATE UNIVERSITY, Bozeman, MT (US)

(21) Appl. No.: 13/160,207

(22) Filed: Jun. 14, 2011

Related U.S. Application Data
(60) Provisional application No. 61/354,677, filed on Jun. 14, 2010.
(60) Provisional application No. 61/357,120, filed on Jun. 22, 2010.

(51) Int. Cl. G01J 3/45

(52) U.S. Cl. 356/451

(57) ABSTRACT

An apparatus includes a single or dual output port, dual-drive Mach-Zehnder Interferometer configured to generate a first optical signal in one path, and to generate a second optical signal in a different path. The apparatus also includes an optical spectrum analyzer configured to receive output from at least one port of the dual-drive Mach-Zehnder Interferometer. A method includes causing radio frequency signals from two different antennae to modulate an optical carrier at a corresponding drive of a dual-drive Mach-Zehnder Interferometer, and causing output from at least one port of the Mach-Zehnder Interferometer to be directed to an optical spectrum analyzer. The method further comprises determining arrival angle at each of a plurality of frequencies in the radio frequency signals based on output from the optical spectrum analyzer.

### CROSS-REFERENCE TO RELATED APPLICATIONS

This application claims benefit of Provisional Appln. 61/354,677, filed Jun. 14, 2010, the entire contents of which are hereby incorporated by reference as if fully set forth herein, under 35 U.S.C. §119(e). This application further claims benefit of Provisional Appln. 61/357,120, filed Jun. 22, 2010, the entire contents of which are hereby incorporated by reference as if fully set forth herein, under 35 U.S.C. §119(e).

### STATEMENT OF GOVERNMENTAL INTEREST

This invention was made with Government support under Contract No. N00014-07-1-1224 awarded by the Office of Naval Research of the Department of the Navy. The Government has certain rights in the invention.

### BACKGROUND OF THE INVENTION

An electronic surveillance system monitoring a complex environment of radio frequency (RF) signals should be able to accurately and simultaneously locate each source of radiation, whether the source is a radar, a communication signal, or a jammer. The receiver system should be able to handle signals with varied and unknown formats operating over a broad frequency range, desired over several to tens of GHz now, and extending to >100 GHz in the future. Rapid assessment is desirable so the coordinates of signals of interest (SOI) can queue other sensors, such as imagery, listening, and radar systems. Reconnaissance platforms should discriminate multiple such complex signals operating over wide bandwidth frequency spans and deal with advanced, brief, and agile communication and radar schemes being developed to elude detection. Various techniques for real-time detection, identification, and location of emitters exist, typically based on measurements of the time difference of arrival at two or more antennae. However, conventional direction finding (DF) and signal intercept methods are ineffective when trying to simultaneously process multiple signals with all these degrees of freedom.

### SUMMARY OF THE INVENTION

Techniques are provided for simultaneous, wideband detection and characterization of radio frequency emissions.

In a first set of embodiments, an apparatus includes a single or dual output port, dual-drive Mach-Zehnder Interferometer configured to generate a first optical signal in one path, and to generate a second optical signal in a different path. The apparatus also includes an optical spectrum analyzer configured to receive output from at least one port of the dual-drive Mach-Zehnder Interferometer.

In another set of embodiments, a method includes causing radio frequency signals from two different antennae to modulate an optical carrier at a corresponding drive of a dual-drive Mach-Zehnder Interferometer, and causing output from at least one port of the Mach-Zehnder Interferometer to be directed to an optical spectrum analyzer. The method further comprises determining arrival angle at each of a plurality of frequencies in the radio frequency signals based on output from the optical spectrum analyzer.

In another set of embodiments, a computer-readable medium or an apparatus is configured to perform one or more steps of the above method.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates an example Mach-Zehnder Interferometer (MZI) as used in some embodiments;

FIG. 2A, FIG. 2B and FIG. 2C are block diagrams that illustrate determination of angle of arrival from power spectra of output from one or more ports of a dual-drive, dual-port MZI, according to one embodiment;

FIG. 3A is a block diagram that illustrate determination of angle of arrival from power spectra of output from one port of a dual-drive, dual-port MZI, according to another embodiment;

FIG. 3B is a graph that illustrates example optical spectrum of both sidebands that are output from a dual-drive, single-port MZI, according to another embodiment;

FIG. 4A, FIG. 4B and FIG. 4C are graphs that illustrate example combinations of both sidebands of a spectrum of an output from a MZI, according to an embodiment;

FIG. 5A is a block diagram that illustrates an example experimental setup, according to an embodiment;

FIG. 5B is a graph that illustrates example time delay experimental results, according to an embodiment;

FIG. 6A is a graph that illustrates an example spectrum for a first emitter, according to an embodiment;

FIG. 6B is a graph that illustrates an example spectrum for a second emitter, according to an embodiment;

FIG. 6C is a block diagram that illustrates example delays and angles of arrival at a pair of antenna for signals from the first and second emitters, according to an embodiment;

FIG. 6D is a block diagram that illustrates an example apparatus for determining simultaneously the spectra that indicate the angles of arrival for signals from both emitters, according to an embodiment;

FIG. 7A is a diagram that illustrates example spectra from both ports of a dual-drive, dual-port MZI at each of several processing steps, according to an embodiment;

FIG. 7B is a diagram that illustrates example frequency dependent phase and time delay derived from the difference and sum of the spectra from both ports of a dual-drive, dual-port MZI at each of several processing steps, according to an embodiment;

FIG. 8 is a diagram that illustrates the relationships of the readout windows required for a single or dual-port operation and an example bandwidth of a SSH material compared to output from both ports of a dual-drive, dual-port MZI, according to an embodiment;

FIG. 9A is a graph that illustrates the determination of delay from the simulated signals, showing where each was measured simultaneously from both emitters in a dual port, single sideband configuration with reduced readout bandwidth, according to an embodiment;

FIG. 9B is a graph of experimental data that illustrates the determination of angle of arrival history measured simultaneously from two RF paths, one with a fixed delay and one with adjustable delay, and reduced readout bandwidth, according to an embodiment;

FIG. 9C is a graph that illustrates example time delay error experimental results for single shot data, where the accuracy is better than demonstrated in FIG. 9B, according to an embodiment;

FIG. 10 is a flow chart that illustrates at a high level an example method for using a dual-drive, dual-port MZI and optical spectral analyzer to determine angle of arrival history, according to various embodiments;

FIG. 11 is a block diagram that illustrates an example computer system upon which an embodiment of the invention may be implemented; and

FIG. 12 is a block diagram that illustrates an example chip set or chip upon which an embodiment of the invention may be implemented.

### DETAILED DESCRIPTION OF EXAMPLE EMBODIMENTS

Various embodiments enable differential phase sensitive power spectrum mapping (DPSPSM) of two RF signals over a broad spectral range (multiple GHz) with fine frequency resolution (sub-MHz), resulting in simultaneous measurement of both the combined power spectrum and the phase difference of the two signals as a function of frequency. The embodiments accomplish DPSPSM by modulating the two signals onto an optical carrier by use of dual-drive Mach-Zehnder Interferometer (MZI) and analyzing the output of the MZI with an optical spectrum analyzer capable of capturing the optical spectrum of transient or non-repetitive signals, if possible by capturing the full spectrum in a single occurrence of the signals of interest. Various embodiments utilize single- or dual-port monitoring of the outputs of the MZI. The embodiments allow for the detection, identification, and localization of non-traditional signals from single or multiple emitters. These embodiments do not involve significant design or modification of two main components that make up the device, the dual-drive MZI and the optical spectrum analyzer. The uniqueness of the illustrated embodiments is in the combination of these components, including configuration of the MZI and the methods by which the spectra produced by the optical spectrum analyzer are processed. The configuration of the MZI component is designed so that the signals are modulated independently onto the carrier in the two arms of the interferometer and interfere in a pre-selected manner with a known dependence on frequency and differential phase. The requirements of the optical spectrum analyzer component is governed by the types of signals to be analyzed. These requirements include one or more of analyzer bandwidth, resolution, dynamic range, measurement time, and latency.

In general, the embodiments cover any method of optical spectrum analysis. Examples of optical spectrum analyzers that could be used include: spatial grating based optical spectrum analyzers, Fabry-Perot or etalon based spectrum analyzers such as virtually imaged phased array (VIPA) analyzers (see Ref [vi]), swept coherent optical spectrum analyzers (see Ref [vii]), and spatial spectral based spectrum analyzers (see Ref. [viii]) including as described in the preferred embodiment However for many applications of interest the optical spectrum analyzer should have favorable characteristics such as:
High bandwidth (multiple gigahertz of bandwidth)
Capture of non-repetitive, transient, or frequency agile signals
High resolution (a few megahertz to sub-megahertz resolution)
Low spurious signals and/or intermodulation distortion
   Some embodiments involve analysis methods to extract both the combined power spectra and differential phases of the two signals from the measured spectra of the output(s) of the MZI obtained by the optical spectrum analyzer. These methods involve processing the RF spectra obtained from both sides of the optical carrier and from one port or both ports of the MZI. The preferred embodiments exploit the symmetries of the spectra obtained when the phase of the MZI is quadrature biased with respect to the optical carrier, but general methods with non-quadrature biased operation are possible in other embodiments. In some embodiments, the techniques are expanded to more than two signals by processing multiple different pairs of signals taken two at a time from the set of all signals to be processed.

An apparatus, method and computer readable medium are described to provide wideband direction finding and spectral mapping using the new configuration. An illustrated embodiment includes a novel combination of a dual-port, dual-drive Mach-Zehnder Interferometer (MZI) and a spectrum analyzer based on spatial-spectral (S2) materials also known as spatial-spectral holographic (SSH) materials for detection, identification, and location of signals from single or multiple emitters. The illustrated embodiment has the following attributes. Other embodiments omit one or more of these attributes or include other properties or are changed in some combination of ways.
(1) Utilizes a photonic processing device where the RF signals from two or more antennae are up-converted onto an optical carrier, interferometrically processed, and monitored by a S2 optical material.
(2) Is a wideband phase sensitive spectral receiver able to perform both spectral mapping and direction finding.
(3) Is a revolutionary approach to spectral mapping and direction finding where multiple signals of interest are simultaneously captured directly in the spectral-domain, in contrast to conventional time-domain approaches.
(4) Facilitates separation in the spectral-domain of complex waveforms that overlap in time, enabling direct spectral phase/delay mapping over a broad frequency band.
(5) Can be used for simultaneous time difference of arrival (TDOA), corresponding angle of arrival (AoA), and spectral estimation of multiple non-traditional signals spread over a wide bandwidth as received by an antenna array.
(6) Provides simultaneous TDOA/AoA measurements for every frequency resolved bin or combination of frequency resolved bins over a wide bandwidth. These measurements can be obtained at kilohertz update rates, providing a history of the frequency bands and AoA of a collection of emitters.
(7) Allows for spectral analysis of individual emitters that are differentiated by their AoA. One or more AoAs can be monitored to assess the modulation and frequency characteristics of the signals emanating from each AoA. This could be used for surveillance or identification of emitters.
(8) Like narrowband antenna array processing that includes I-Q quadrature down-converters; but, unlike such narrowband processing, allows broadband operation for detection of multiple diverse signals simultaneously.

(9) In some embodiments, this architecture is extended to deal with multiple antenna outputs, implying multiple RF drives, and multiple interferometric paths implying multiple ports, since any pairwise or other combinations of the drives and ports can be reduced to a single or dual-port, dual-drive MZI configuration.

The illustrated embodiment has two main components: a dual-port, dual-drive Mach-Zehnder Interferometer (MZI) and a spatial-spectral (S2) spectrum analyzer. Other embodiments could include other interferometric devices or other spectrum analysis devices to accomplish the AoA and spectrum analysis operations.

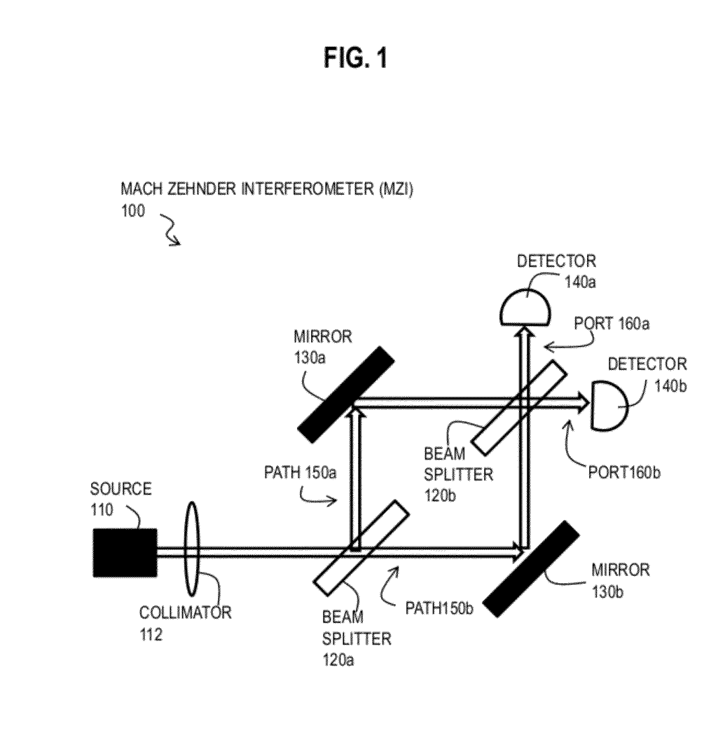

FIG. 1 is a block diagram that illustrates an example Mach-Zehnder Interferometer (MZI) 100 as used in some embodiments. Collimated light from source 110 and collimator 112 is split into two paths, path 150a and path 150b at beam splitter 120a. The paths are caused to converge again, e.g., by the use of minors 130a and 130b, at beam splitter 120b. The interference in one direction is encompassed in a first beam that passes through one port, e.g., port 160a, and is detected, e.g., at detector 140a. The interference in a perpendicular direction is encompassed in a second beam that passes through a second port, e.g., port 160b, and is detected, e.g., at detector 140b. Thus the illustrated MZI is said to be a dual-port MZI.

The interference pattern in each direction is affected by differences in the paths 150a and 150b. Typically, differences in the paths are driven by one or more optical components. A MZI with an optical component in each of path 150a and path 150b is said to be a dual-drive MZI. In many of the embodiments described below, an optical modulator, such as an electro-optical modulator (EOM) or an acoustic optical modulator (AOM) constitutes the optical drive in each of the two paths 150a and 150b.

In the illustrated embodiment, which utilized an S2 spectrum analyzer as one or more of the detectors 140a and 140b, the spectrum analyzer operates in two steps. The S2 material first records the full complex optical power spectrum from the interferometer, including the upper and lower sidebands around the optical carrier. The upper and lower sidebands after the interferometer are sensitive to the relative phase at each frequency of the signals of interest (SOI) captured by the antenna array elements. The recorded broadband information is then read out by frequency scanning the S2 material and digitizing the output with a low-speed, high-resolution analog-to-digital converter. (See, for example, reference i, T. Chang, R. K. Mohan, M. Tian, T. L. Harris, W. R. Babbitt, K. D. Merkel, Frequency-chirped readout of spatial-spectral absorption features, Physical Review A 70, 063803 (2004) for a description of the recording and read-out of optical spectra in an SSH material.) Post-processing results in a simple and direct estimation of both the power spectrum and relative phase delay at each frequency over the entire bandwidth in a single capture. The complete capture of all frequencies at once greatly increases the probability of intercept over frequency scanned detection systems.

A powerful aspect of this S2 correlative spectrum analyzer's operation is the interference of the SOI from one antenna with its time delayed and/or phase shifted replica from a second antenna element, which is recorded as a spectral grating (hologram) in the S2 material. The spectral grating contains both the SOI's full spectral power and relative spectral phase information. The ability to capture the interference spectrum for wide bandwidth signal is made possible by the S2 material's wide inhomogeneous broadened absorption line (typically >20 GHz, and up to 100 GHz) and its very fine homogeneous linewidth providing frequency resolution (down to 10 kHz) and high intrinsic dynamic range.

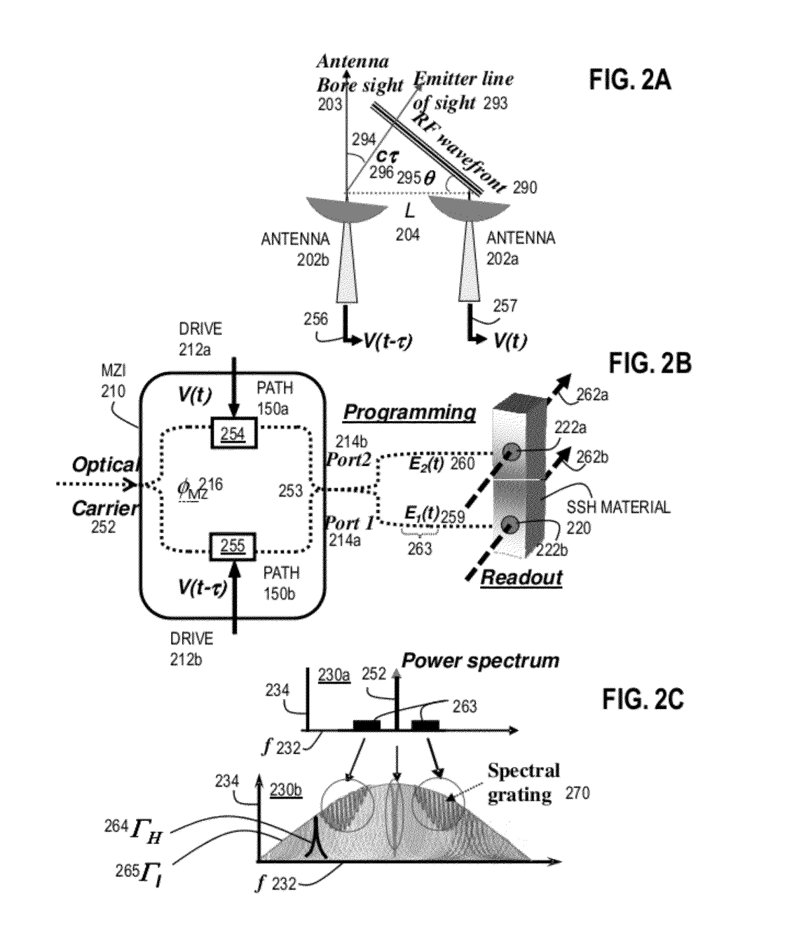

FIG. 2A, FIG. 2B and FIG. 2C are block diagrams that illustrate determination of angle of arrival from power spectra of output from one or more ports of a dual-drive, dual-port MZI, according to one embodiment. FIG. 2A depicts two antennae 202a and 202b in an example phased array; FIG. 2B shows an example MZI 210 configured with an example SSH material 220 as an optical spectrum analyzer; and FIG. 2C shows example spectra at one port (power spectrum 230a) and in the SSH material (power spectrum 230b).

The illustrated embodiment includes a dual-drive, dual-port Mach-Zehnder interferometer (MZI) 210 with two optical component modulators 254 and 255 that modulate an optical carrier 252 based on voltage outputs V(t) 212a and V(t−τ) 212b from corresponding two antennae 202a and 202b. Each drive of the MZI is driven by one of the antennae. The MZI directly maps the power spectra of the unknown RF signals received from two antennae into the optical domain, as shown in power spectrum graph insert 230a with frequency axis 232 and power in arbitrary units on vertical axis 234. The MZI is configured to introduce a phase shift θ_{MZ} 216 between the two paths.

The sum of the upper and lower sidebands at any frequency from the carrier gives a measure of the signal power at that frequency. The difference in amplitudes of the upper and lower sidebands at a frequency from the optical carrier provides information from which the differential phase between the two signals at that frequency can be obtained. Knowledge of the relative phase φ at that frequency from two antennae can be used for precise time delay estimation of signals received by a phased antenna system pointed in bore site direction 203. For a known separation (L) 204 between antennae in the array, determination of the spectral phase φ or time delay τ between the signals enables angle of arrival θ 294 estimation on the source direction 293 of the emission of the signals that form a wave front 290. This configuration yields an unambiguous estimation of the AoA 294 when the separation L 204 is <λ_{RFmin}/2, where λ_{RFmin} is the radio frequency wavelength of the highest frequency component of interest in the signals of interest.

The optical output at each port 214a and 214b is stored in a corresponding portion 222a and 222b of an SSH material, where an incident chirped probe signal outputs a corresponding readout signal 262a and 262b. FIG. 2C depicts a conceptual diagram of the absorption spectrum 230b in the SSH material where the output of one port is recorded as a spectral grating 270 on the inhomogeneously broadened absorption spectrum Γ_{I} 265. The homogeneous absorption line of an individual absorber is depicted as Γ_{H} 264.

The illustrated AoA system includes a dual driven Mach-Zehnder interferometer 210. A narrowband laser source 352 is split and coupled into two modulators 254 and 255 (e.g., electro-optic phase EOM). The modulators are driven with the RF signals of interest (e.g., V(t) 212a and V(t−τ) 212b, one from each antenna 202a and 202b). In the simplest case, the signals received by the two antennae in an antenna array are from a single emitter and have a delay τ, which depends on the angle θ295,294 of the RF wavefront 290 from the emitter with respect to the line between the two antennae. Thus, the RF signals driving the EOMs contain a time difference τ that is dependent on the angle of arrival and thus can be used to locate the direction of the emitters.

The time difference of arrival for a single (k^{th}) emitter is

τₖ=L sin(θₖ)/c,

and can be expressed as a frequency dependent phase

φₖ(ν)=ντₖ=νL sin(θₖ)/c,

where θₖ is the angle of arrival from the k^{th} emitter, L is the antenna separation, ν=2πf, and f is the RF frequency of interest. The discussion of the illustrated embodiment considers the processing of a single emitter at first and is then generalized to multiple emitters later in the discussion. Through the modulation process, the laser carrier obtains sidebands whose spectra contain information about the amplitude and phases of the RF signals from the array. After modulation with the RF signal of interest, the two paths are recombined so that the two optical signals interfere. The MZI is biased so that without modulation the two paths when combined have an optical phase difference at the optical carrier frequency of φ_{MZ}. The resulting optical spectrum of either port 214a or port 214b of the interferometer contains a carrier, an upper sideband consisting of the RF spectrum of the unknown RF signal, and a lower sideband consisting of the mirror image of the RF spectrum that are all modulated with a raised sinusoid whose spectral period is the inverse of the time delay, τₖ, between the two RF signals and whose phase is set by the overall bias of the interferometer, φ_{MZ}.

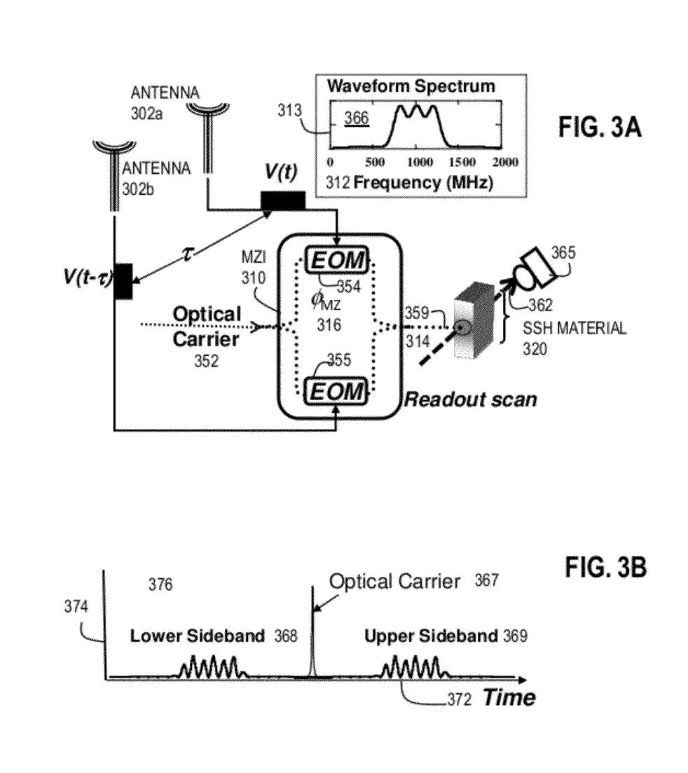

FIG. 3A is a block diagram that illustrates determination of angle of arrival from power spectra of output from one port of a dual-drive MZI, according to another embodiment. The voltage outputs V(t) and V(t−τ) with spectra shown in insert graph 366 (having frequency axis 312 and power axis 313) from the two antennae 302a and 302b, respectively, drive corresponding EOM 354 and EOM 355 of the MZI 310 with φ_{MZ} 316. The beam 359 from output port 314 is recorded in SSH material 320 and probed with a readout scan, such as a chirp, to produce readout signal 362 detected at detector 365, then digitally processed to recover the optical spectrum.

FIG. 3B is a graph that illustrates example optical spectrum 376 of output from a dual-drive, dual-port MZI, according to another embodiment. The horizontal axis 372 is time of the readout signal 362, which corresponds to optical frequency, based on the chirp rate of the readout scan. The vertical axis 374 is spectral power density in arbitrary units. The optical carrier appears as spike 367 between the lower sideband 368 and the upper sideband 369.

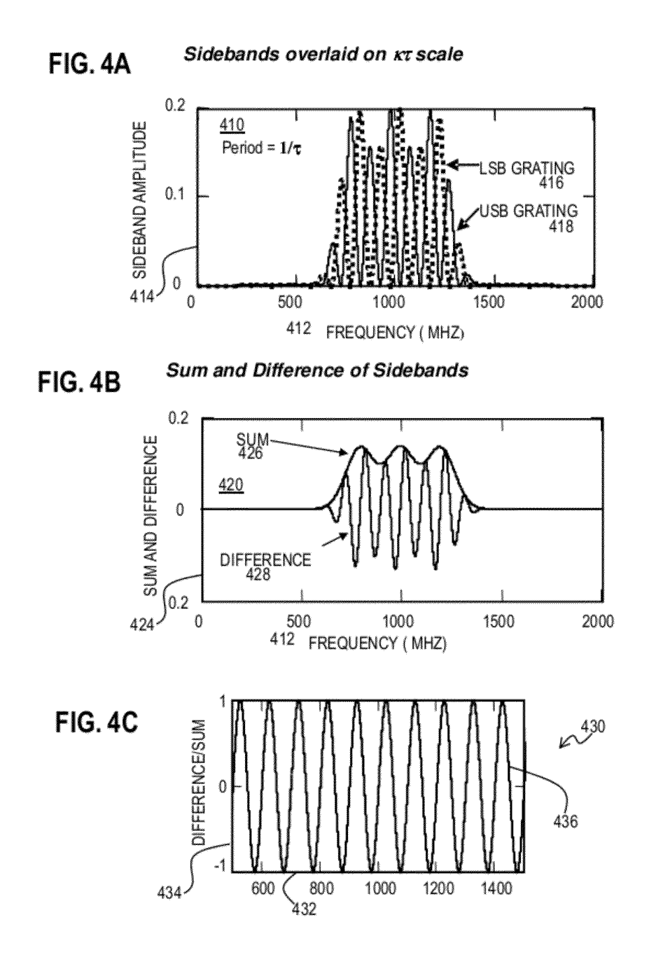

FIG. 4A, FIG. 4B and FIG. 4C are graphs that illustrate example combinations of both sidebands of a spectrum of an output from a MZI, according to an embodiment. This illustration is done with L>>λ_{RFmin}/2, which is not the preferred embodiment and is used for descriptive purposes only. FIG. 4A is a graph 410 with horizontal frequency axis 412 and vertical sideband amplitude axis 414. The zero of the frequency axis 412 corresponds to the optical carrier frequency. The upper sideband is plotted as solid trace 418 and a minor image of the lower sideband around the optical carrier is plotted as dashed trace 416. FIG. 4B is a graph 420 with horizontal frequency axis 412 and vertical amplitude axis 424. The sum of the upper sideband and mirrored lower sideband is plotted as trace 426; and represents the power spectrum of the signal of interest. The difference of the upper sideband and mirrored lower sideband is plotted as trace 428. FIG. 4C is a graph 430 with expanded horizontal frequency axis 432 and vertical amplitude axis 434. The graph depicts the ratio of the difference trace 428 divided by the sum trace 426. The spacing of the phase peaks in trace 436 represents the reciprocal of the time delay τ, e.g., represents 1/τ.

### Programming

The theoretical underpinnings of the working of the device are provided here; however the embodiments of the invention are not limited by the completeness or accuracy of the following descriptions. In general, for multiple emitters, the signals from the two antennae 256 and 257 that drive the EOMs 254 and 255 can be written as the sum of signals,

$${V}_{A} ( t ) = {\sum }_{k}^{ } {V}_{k} ( t ) \\ and \\ {V}_{B} ( t ) = {\sum }_{k}^{ } {V}_{k} ( t - {τ}_{k} ) , \qquad ( 1 )$$

where the sum is over all of the emitters. The different τₖ correspond to different θₖ of the multiple emitters. The theory below analyzes the operation for a single emitter (k) and then the operation with multiple emitters is discussed.

The optical carrier is split with a splitter and modulated by EOMs in each arm. The resultant modulated EOM outputs can be represented by their fields as they would appear in Port 1 of the MZI (the light port when φ_{MZ}=0) as

E_{EOM}^{A}(t)=E₀ cos(ω_{L}t+βₖ(t)) and

E_{EOM}^{B}(t)=ηE₀ cos(ω_{L}t+βₖ(t−τ)+φ_{MZ}) (2)

where ω_{L} is the laser carrier frequency in angular frequency units, E₀ is the laser field amplitude in the path that modulated by EOM with un-delayed input 257, ηE₀ is the laser field amplitude in the path that is modulated by EOM with delayed input 256, βₖ(t)=π(Vₖ(t)/V_{π}) and φ_{MZ} is the added phase delay on path B due to bias of the interferometer. The variable η takes into account the imbalance in the input splitter. For a well balanced MZI biased at quadrature, η=1 and φ_{MZ}=π/2.

The two electric fields from the EOMs are then recombined with a 2×2 fiber combiner. In the illustrated embodiment, the output combiner is assumed perfect, but it need not be perfect for the various embodiments to operate effectively. The electric field out of the two ports of the MZI, viz., Ports 1 and 2 illustrated at 214a and 214b in FIG. 2B, are

E₁(t)=E_{EOM}^{A}(t)+E_{EOM}^{B}(t) and

E₂(t)=E_{EOM}^{A}(t)−E_{EOM}^{B}(t). (3)

Assuming βₖ(t)<<1, the two components can be rewritten as

E_{EOM}^{A}(t)≈E₀ cos(ω_{L}t)−βₖ(t)E₀ sin(ω_{Lt)}

E_{EOM}^{B}(t)≈ηE₀ cos(ω_{L}t+φ_{MZ})−ηβₖ(t−τₖ)E₀ sin(ω_{L}t+φ_{MZ}) (4)

Consider programming the S2 material with the output from Port 1, E₁(t). A simplified schematic of the programming and readout is shown in FIG. 2B and FIG. 3A. As described above, the interferometer 210 or 310 enables interference of the two time-delayed RF waveforms 256 and 257 received by the antennae 202b and 202a, respectively. The optical beam out of either port of the interferometer contains the relative phase and power spectrum information of the RF signals of interest. In the case of utilizing only Port 1, as illustrated in FIG. 3A, the power spectrum of the optical signal, E₁(t) is recorded for every frequency in the S2 material. The spectral interference fringe pattern depends on the time delay and the frequency.

$${E}_{1} ( t ) = ( 1 - η ) {E}_{0} cos ( {ω}_{L} t ) + 2 η {E}_{0} cos ( {ω}_{L} t + {φ}_{MZ} / 2 ) cos ( {φ}_{MZ} / 2 ) - {β}_{k} ( t ) {E}_{0} sin ( {ω}_{L} t ) - {ηβ}_{k} ( t - {τ}_{k} ) {E}_{0} sin ( {ω}_{L} t + {φ}_{MZ} ) \qquad ( 5 )$$

Keeping only the positive frequencies and Fourier transforming yields

$${E}_{1} ( ω ) = {E}_{0} δ ( ω - {ω}_{L} ) ( ( 1 - η ) / 2 + ηexp ( {iφ}_{MZ} / 2 ) cos ( {φ}_{MZ} / 2 ) ) + {iβ}_{k} ( ω - {ω}_{L} ) {E}_{0} ( 1 + ηexp ( - i ( ω - {ω}_{L} ) {τ}_{k} ) exp ( {iφ}_{MZ} ) ) / 2 \qquad ( 6 )$$

where βₖ(ν) is Fourier transform of βₖ(t), ω represents optical angular frequencies, and ν represents RF angular frequencies. Since βₖ(t) is real, βₖ(−ν)=βₖ*(ν). The optical power out of Port 1 at any given optical frequency ω is P₁(ω)=|E₁(ω)|².

Only positive optical frequencies are considered in this analysis, as is standard practice. The expressions for programming the S2 material from Port 2 can be found by replacing η with −η in Equations (6, 7).

At this point, if the phase of the MZI, θ_{MZ}, is known, then both the relative time delay and the power spectrum of the unknown signals can be extracted by processing of the optical spectrum. In the illustrated embodiment, the optical spectrum is processed with an S2 processor, but any optical spectrum analyzer capable of capturing the wideband spectra of the upper and lower sidebands of the optical output signal from the MZI would provide the information needed to extract the relative time delay between the signals. As shown below, in other embodiments any optical spectrum analyzer capable of capturing the wideband spectra of the upper or lower sidebands of the optical output signal from both ports of the MZI would also provide the information needed.

### S2 Recording

To process the spectrum in the illustrated embodiment, an S2 material 220 (or 320 in FIG. 3) is used to capture the optical signals through the spectral hole burning process. These spectral components in the optical signals excite the corresponding absorbers in the S2 material that are resonant at those frequencies and create spectral features in the absorption profile. The important function that the S2 material provides is as a wideband, high resolution optical spectrum analyzer. The S2 material consists of billions of high density atomic absorbers (on the order of 10⁹ absorbers per cubic wavelength) with narrow resonance profiles Γ_{H} 264 (kHz to MHz) that are spread inhomogeneously over large bandwidths forming a broad (10's of GHz) absorption profile Γ_{I} 265 due to variations in the material. When the programming light is passed through the material, the individual atomic absorbers are selectively excited according to the spectral components of the input optical fields to generate the spectral grating 270. For a single frequency programming beam only the atoms at the laser frequency are excited, which modifies the absorption coefficient for subsequent fields at that frequency and forms what is known as a spectral hole in the broad absorption profile. When the fractional excitation of the material remains small, the change in the frequency resolved absorption profile accurately records the optical power spectrum of input programming beam. The spectral features recorded remain for at least the lifetime of the excited state, which is generally longer than the coherence time of the material, 1/Γ_{H}. Additionally, depending on the material, the spectral features can persist for much longer due to atoms getting trapped in long lived metastable or off-resonant ground state hyperfine levels.

### S2 Readout

The absorption profile modified by the programming beam and stored through spectral hole burning process can then be scanned out by recording the transmission of a linear frequency optical chirp (see, for example, refs i, ii, iii) through the programmed material with a photodetector (e.g., photodetector 365 in FIG. 3). The time-frequency correspondence of the linear frequency chirp produces the result that the time domain signal acquired with the photodetector (as shown in FIG. 3B) can be used to recover the power spectrum recorded into the material.

Using the spectral analysis function of the S2 material to obtain the high resolution optical power spectrum (e.g., shown in FIG. 3B), the powers detected at the sidebands 368 and 369 for either Ports 1 and 2, can be written as:

P₁₊^{(k)}(ν)=|βₖ(ν)|²E₀²(1+η²+2η cos(ντₖ)cos(φ_{MZ})+2η sin(ντₖ)sin(φ_{MZ}))/4

P₁₋^{(k)}(ν)=|βₖ(ν)|²E₀²(1+η²+2η cos(ντₖ)cos(φ_{MZ})−2η sin(ντₖ)sin(φ_{MZ}))/4

P₂₊^{(k)}(ν)=|βₖ(ν)|²E₀²(1+η²−2η cos(ντₖ)cos(φ_{MZ})−2η sin(ντₖ)sin(φ_{MZ}))/4 (7)

P₂₋^{(k)}(ν)=ββₖ(ν)|²E₀²(1+η²−2η cos(ντₖ)cos(φ_{MZ})+2η sin(ντₖ)sin(φ_{MZ}))/4,

where ν is the absolute difference between the optical frequency and the optical carrier frequency, ν=abs(ω−ω_{L}). Thus, the sideband spectra are just a modulated version of the RF spectrum of the input RF signal. The four expressions in equation (8) refer to the spectra obtained from the upper sideband of Port 1, the lower sideband of Port 1, the upper sideband of Port 2, and the lower sideband of Port 2, respectively.

### Post-Processing

Post-processing is performed once the lower and upper sideband spectra (20) are recovered as shown in FIG. 4.

The sum trace 426 and difference trace 428 of the upper and lower sidebands of a single port are taken. The difference of the powers in the sidebands is related to the phase of the RF signals relative to the optical carrier and contains the time delay information, while the sum of sidebands yields the power spectrum of the intercepted RF signals. For just processing of the upper and lower sidebands of Port 1, the sum and difference spectra are

P₁₊^{(k)}(ν)−P₁₋^{(k)}(ν)=|βₖ(ν)|²E₀²η sin(ντₖ)sin(φ_{MZ})

P₁₊^{(k)}(ν)+P₁₋^{(k)}(ν)=|βₖ(ν)|²E₀²(1+η²+2η cos(ντₖ)cos(φ_{MZ}))/2 (8)

The ratio of the difference spectrum 428 to the sum spectrum 426 of the sidebands normalizes the interference spectrum and enables the extraction of the desired time delay independent of the RF power at ν, provided the contrast and MZI phase are known and sufficient power at ν to overcome the noise power at ν. Eq. (9) yields

$${S}_{1}^{( k )} ( v ) = \frac{{P}_{1 +}^{( k )} ( v ) - {P}_{1 -}^{( k )} ( v )}{{P}_{1 +}^{( k )} + {P}_{1 -}^{( k )} ( v )} = \frac{2 η sin ( v {τ}_{k} ) sin ( {φ}_{MZ} )}{( 1 + {η}^{2} + 2 ηcos ( v {τ}_{k} ) cos ( {φ}_{MZ} ) )} \qquad ( 9 a )$$

It is illustrative to look at the case of an ideal interferometer (i.e. η=1) that is configured to operate at quadrature (φ_{MZ}=±π/2). The ratio can then be evaluated simply to be

S₁^{(k)}(ν)=sin(ντₖ) (10b)

and is plotted in FIG. 4C 430. Note that in order to illustrate the sinusoidal behavior of the ratio, the examples in FIG. 3 and FIG. 4 assume L>>λ_{RFmin}/2. In the preferred embodiment L<λ_{RFmin}/2. Equation (10a and 10b) can be used to estimate the time delay τₖ of the RF signals from a single emitter, k, between the two antenna outputs. The relative delay can be determined as

τ=arcsin(S₁^{(k)}(ν))/ν (10c)

The delayed time of arrival can be estimated for each RF frequency component of the signal independently. For a single emitter, the angle of arrival (AoA) is given by θₖ=arcsin(cτₖ/L). Note that the determination of the delay time only requires any one spectral component of the input RF signal. It should be noted that in order to estimate a delay at a given frequency ν, the input signal should have sufficient signal power at that frequency ν in order to overcome noise or distortion in the system. If the signal from an emitter is broadband or made up of several frequency components, the delay can be determined for each frequency bin that has sufficient power and the collection of measurements can be used to give greater confidence to the delay estimation than would be obtained from the measurement at only one frequency component. However, as noted above, this is not required and only a single frequency component may be sufficient to obtain an adequate estimation of the delay of the single emitter and thus determine the angle of arrival.

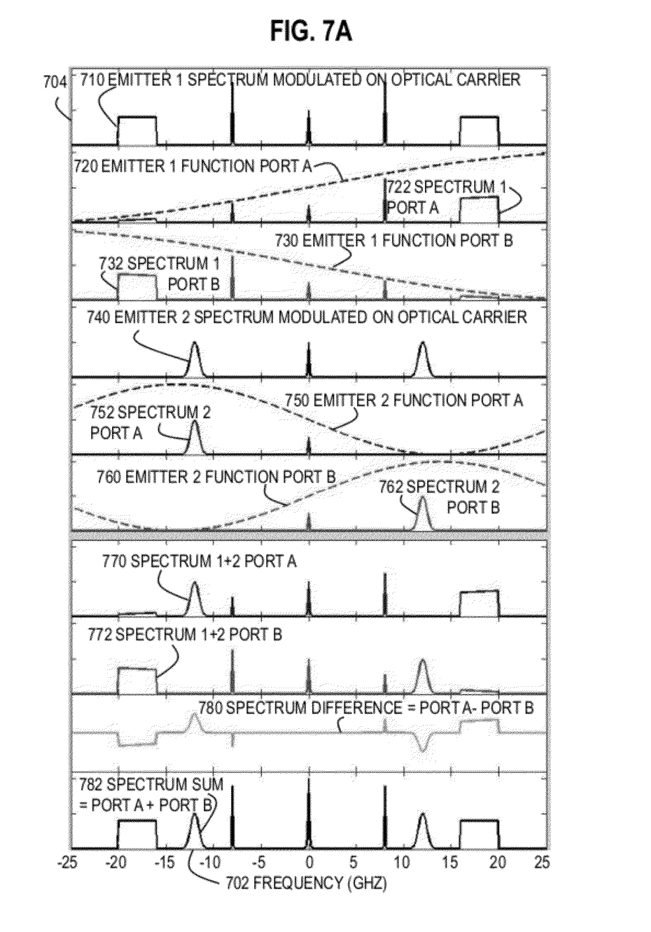

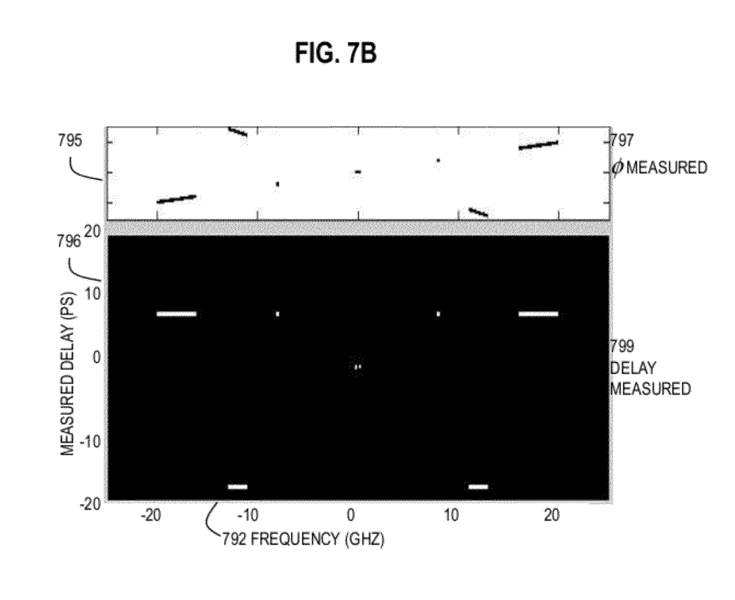

As stated earlier and represented in equation (1), the signals arriving at the antenna array can be from multiple emitter sources. If the signals from emitters at different angular directions are spectrally overlapping, the analysis becomes more complicated. Examples are shown in a simulated embodiment described in more detail below with respect to FIG. 7 through FIG. 10. If the spectra or number of emitters is known, it may be possible to estimate angle of arrivals (AoA) for the emitters with just two antennae. Typically, more than one antenna pair is used to resolve ambiguities introduced by spectrally overlapping signals from emitters at more than one AoA. Algorithms can be developed to achieve AoA information by processing the sideband spectra from multiple antenna pairs.

In the spectral regions in which the emitters are non-overlapping, the RF signal emitters from multiple directions can be located simultaneously and spectrally distinguished. In a spectral region in which only one emitter has power and no other emitters have power, the above processing estimates the AoA of that emitter and provides the spectrum of that emitter in this region. For any emitter in a set of emitters that has a unique region or set of frequencies that it broadcasts and no other emitters are broadcasting in those regions or at that set of frequencies simultaneous with the given emitter, AoA and spectra of that emitter can be estimated. This allows multiple emitters from multiple directions to be identified (via their spectra) and located (via their direction). It is advantageous when the emitters are not simultaneously spectrally overlapping for the above processing techniques to distinguish the direction of different emitters.

### Dual Port Processing

Information can be combined from both ports to obtain differential delay information that does not depend on the contrast, η. This would be a more robust embodiment. Equations (7) can be used to develop an expression that uses information from both ports of the MZ interferometer for estimating the time difference of arrival information for a given frequency.

In one embodiment, the upper and lower sidebands of Ports 1 and 2 are used to derive sum and difference spectra.

P₁₊^{(k)}(ν)−P₁₋^{(k)}(ν)=|βₖ(ν)|²E₀²η sin(ντₖ)sin(φ_{MZ})

P₁₊^{(k)}(ν)+P₁₋^{(k)}(ν)=|βₖ(ν)|²E₀²(1+η²+2η cos(ντₖ)cos(φ_{MZ}))/2

P₂₊^{(k)}(ν)−P₂₋^{(k)}(ν)=−|βₖ(ν)|²E₀²η sin(ντₖ)sin(φ_{MZ}) (11)

P₂₊^{(k)}(ν)+P₂₋^{(k)}(ν)=|βₖ(ν)|²E₀²(1+η²−2η cos(ντₖ)cos(φ_{MZ}))/2

The sums and differences can be added and subtracted and ratios taken in a variety of combinations to minimize the dependence of the estimations on particular parameters. Of particular interest is the case

$$\frac{( {P}_{1 +}^{( k )} ( v ) - {P}_{1 -}^{( k )} ( v ) ) + ( {P}_{2 -}^{( k )} ( v ) - {P}_{2 +}^{( k )} ( v ) )}{( {P}_{1 +}^{( k )} ( v ) + {P}_{1 -}^{( k )} ( v ) ) - ( {P}_{2 +}^{( k )} ( v ) + {P}_{2 -}^{( k )} ( v ) )} = tan ( v {τ}_{k} ) tan ( {φ}_{MZ} ) \qquad ( 12 )$$

Thus the differential delay time of arrival of the k^{th} emitter at any frequency ν can be obtained from

$${τ}_{k} = ( \frac{1}{v} ) arc tan ( \frac{1}{tan ( {φ}_{MZ} )} ( \frac{( {P}_{1 +}^{( k )} ( v ) - {P}_{1 -}^{( k )} ( v ) ) + ( {P}_{2 -}^{( k )} ( v ) - {P}_{2 +}^{( k )} ( v ) )}{( {P}_{1 +}^{( k )} ( v ) + {P}_{1 -}^{( k )} ( v ) ) - ( {P}_{2 +}^{( k )} ( v ) + {P}_{2 -}^{( k )} ( v ) )} ) ) \qquad ( 13 )$$

The angle of arrival (AoA) is determined from θₖ=arcsin(cτₖ/d). Therefore, by utilizing both ports of the Mach-Zehnder, one can obtain an expression for the relative time delay that is independent of the contrast, η, and is thus more robust. As above, multiple emitters can be processed provided their emissions are not completely overlapping or if two or more pairs of antennae are processed.

### Partial Bandwidth Processing

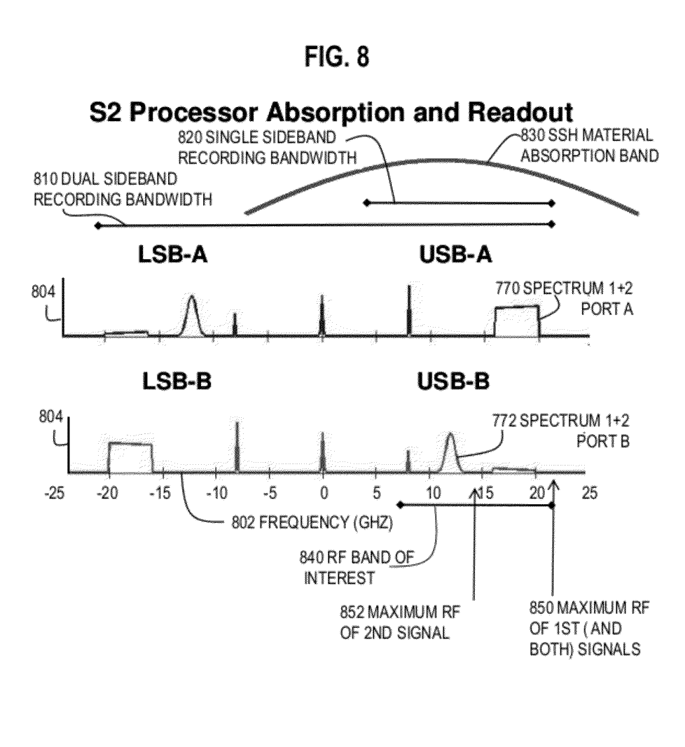

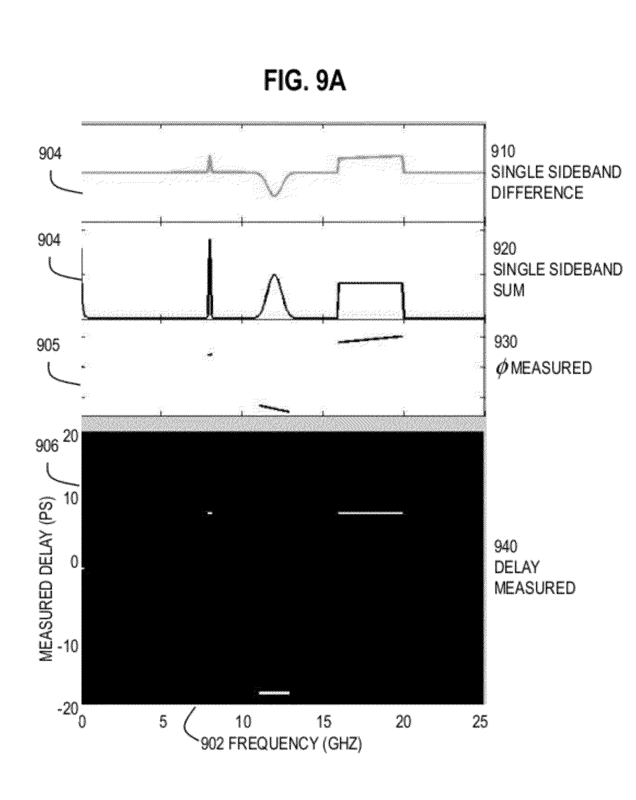

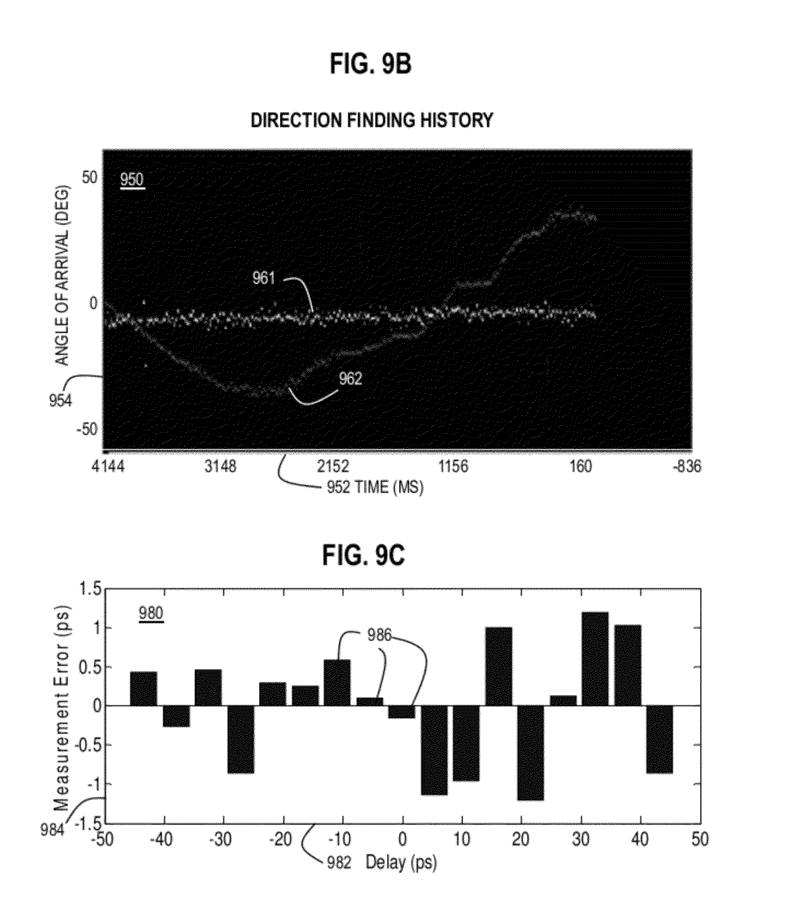

In some embodiments, information is combined from one sideband of each of both ports to obtain differential delay information with a fraction of the bandwidth in the spectrum analyzer used by the above methods. The feasibility of such an embodiment is presented in more detail in a demonstration described in a later section with reference to FIG. 8, FIG. 9A, FIG. 9B and FIG. 9C.

### Notable Points

As can be seen, this novel combination of a S2 spectrum analyzer and a dual drive interferometer enables a straightforward measurement of the differential time delay and the corresponding AoA at every resolvable frequency at which there is significant signal power. Although this interferometric technique looks very similar to previous range-Doppler processing methods (references iv, v), it is in fact quite different. In the range-Doppler processing method, a large bandwidth of the power spectral density of the spectral grating is used to recover the time delay. The prior art involves a spectrum broad enough so that several spectral periods are recorded. The time resolution of the range-Doppler processor depends on the bandwidth of the signal. On the other hand, the interferometric technique of the illustrated embodiments utilizes the phase at each frequency bin of the spectral grating. The embodiments do not require broadband spectra and can be used to obtain time delays from sparse spectra or even single RF tones.

For transient signals, there are no other optical spectrum analysis methods, known to the authors, with as much resolving power (i.e. number of spectral bins) or resolution (e.g. <1 MHz) as S2 material based spectral mapping At the present time, over 50,000 frequency channels can be captured simultaneously in one laser spot with a bandwidth over 20 GHz and updated on time scales of one millisecond.

An important attribute of S2 materials is their massive spatial parallelism that enables real-time simultaneous processing of multiple antenna element pairs at different spatial locations in a 1 cm³ S2 material, providing a variety of potential configurations and monitoring schemes.

The dual port processing has advantages in redundancy and mitigation for non-ideal operation. As described above, the processing was extended to include a novel post-proces sing algorithm that utilizes the power spectrum of each of the spectral components recorded in both ports on two different spots on the S2 crystal to extract the desired time difference of arrival information. By utilizing both ports of the MZI EOM interferometer, an expression for the time difference of arrival is obtained. The two port TDOA expression is independent of the contrast of the interferometer and is thus more robust.

In some embodiments, the dual-port processing offers the advantage of determining angle of arrival with a fraction of the bandwidth required for the single port technique.

### Demonstration

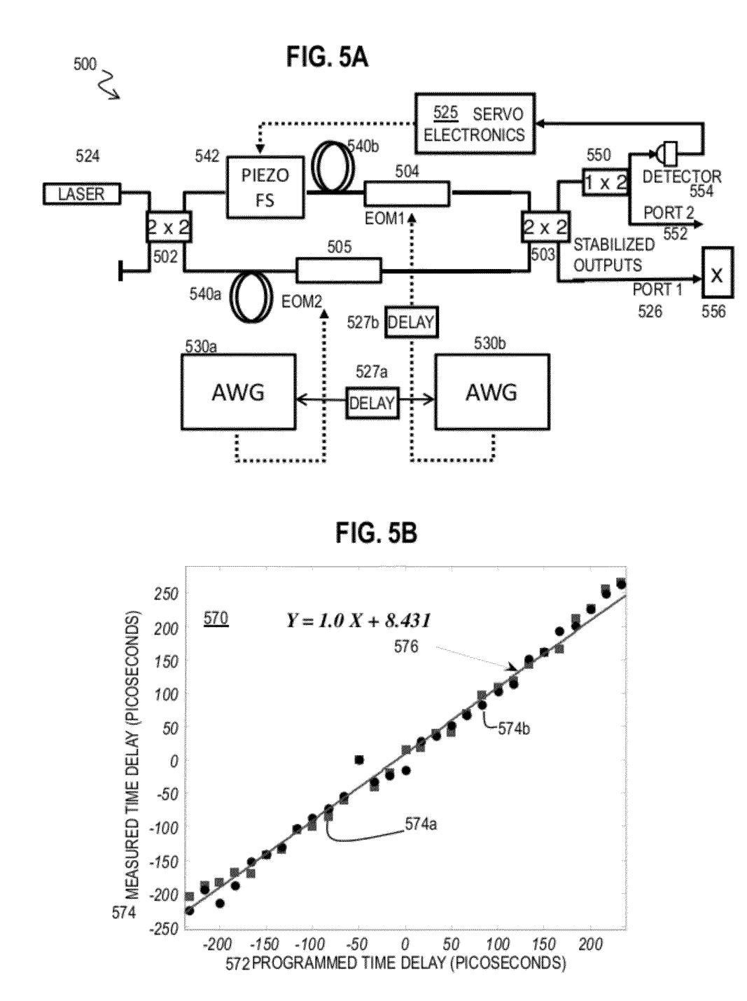

To demonstrate the time difference of arrival estimation capability of both sidebands, a series of experiments were performed. FIG. 5A is a block diagram that illustrates an example experimental setup 500, according to an embodiment. A correlative spectrum receiver 556 based on a cryogenic Tm:YAG crystal that operates on wide bandwidth RF signals modulated onto a stabilized optical carrier at 793 nm was utilized. The optical carrier was generated from a frequency doubled narrow (˜kHz) linewidth fiber laser 524 operating at 1586 nm. The stabilized laser source beam was split in beam splitter 502 and coupled into two electro-optic modulators (EOM), e.g., 504, and 505. Two 20 GHz EOMs were utilized for modulation. The outputs of the EOMs were recombined (e.g., in beam splitter 503) in a Mach-Zehnder (MZ) interferometric configuration.

The optical signals after the MZ EOM interferometer were amplified with a semiconductor optical amplifier (500 mW, not shown). The fiber path lengths were stabilized with an in-line fiber stretcher 542 using a servo 525 in a feedback loop comprising splitter 550 and detector 554. The interferometric setup was configured to operate close to quadrature (φ_{MZ}=±π/2). The EOMs were driven with the RF signal of interest (SOI) from arbitrary waveform generators 530a and 530b. To simulate signals received by an antenna array a known RF delay was introduced between the RF signals from the AWGs 530a and 530b driving the EOMs 505 and 506, respectively. Temporal aperture was extended using fiber coils 540a and 540b up-beam of the EOMs 505 and 504, respectively.

The RF waveforms were generated with arbitrary waveform generators 530a and 530b and the time delays were generated electronically with a digital delay and pulse generator 527a. The RF patterns spanning 400-800 MHz were electronically delayed and modulated onto the optical carrier. A single port 526 output of the MZ interferometer was used to program the S2 crystal 556. The programmed spectral gratings were read out for each time delay with a wideband optical chirp in an angled-beam geometry. An output of the balanced detector was digitized and post-processed according to the procedure described above, to yield sinusoidal signals that were used to estimate the time delay.

This technique was used to measure time differences of arrival. The RF patterns spanning 400-800 MHz were delayed by +/−200 picoseconds (ps) with a mechanical phase shifter (in-line trombone) as delay 527b. For every programmed time delay, the optical chirp readout of the signal stored in the crystal 556 was detected and digitized. To estimate the performance of the TDOA system, a comparison between the time delays obtained using the approach described above and the programmed time delays was made.

FIG. 5B is a graph that illustrates example time delay experimental results from the equipment described above, according to an embodiment. FIG. 5B shows the average of the measured time-delays 574a over the 450-600 MHz spectral region for every programmed time-delay. Data were collected over several independent captures and averaged 574a and 574b. The root mean square (RMS) error in the delay estimation is about 16 ps for data between 450-600 MHz captured with 100 kHz resolution. The RMS error of the delay estimation was measured to be about 16 picoseconds (ps, 1 ps=10⁻¹² seconds). This corresponds to a phase resolution of about 3.6° for an RF frequency component at 500 MHz, over a total demonstrated unambiguous field of view of ˜λ/4, (±250 ps). Significantly, it should be noted that the time delays were extracted over the entire bandwidth in a single capture and processed simultaneously at every resolvable frequency (with a resolution of 100 kHz). The larger errors tended to be associated with the larger delays, and are much smaller than 16 ps for delays on the order of 50 ps or less, as shown in more detail below with reference to FIG. 9C.

### Other Embodiments

In other embodiments, the inputs to the two EOMs are outputs of RF cables that have one or more sources of RF signals coupled into each cable. These embodiments can be used to synchronize the delay between the sources or to measure the dispersion in the cables. If there are multiple signals in each cable, various embodiments are used to determine the differential delays of the sources so that different frequency bands are corrected (synchronized).

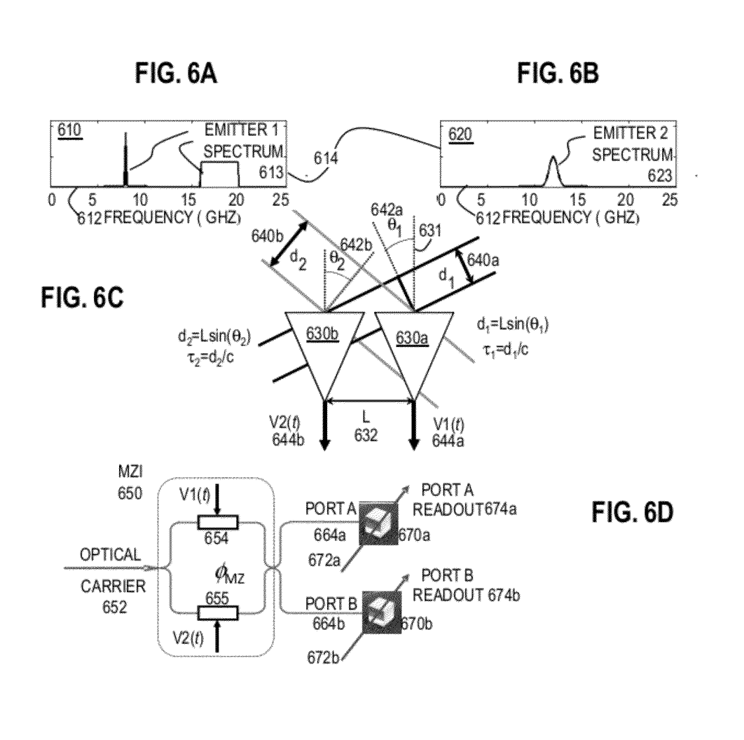

A simulation was performed to illustrate the simultaneous determination of angle of arrival time history at two antennae from two different emitters with very different spectra. FIG. 6A is a graph 610 that illustrates an example spectrum 613 for a first emitter, according to an embodiment. The horizontal axis 612 is frequency in Gigahertz (GHz) and vertical axis 614 is spectral power density in arbitrary units. The spectrum 613 includes a narrow peak at about 8 GHz and a plateau at 16 to 20 GHz. The simulated time delay applied to this spectrum was 8 picoseconds. FIG. 6B is a graph 620 that illustrates an example spectrum 623 for a different second emitter, according to an embodiment. The horizontal axis 612 and vertical axis 614 are the same as for FIG. 6A. The spectrum 623 includes a single peak at about 12 GHz. The simulated time delay applied to this spectrum was −18 ps.

FIG. 6C is a block diagram that illustrates example delays and angles of arrival at a pair of antennae for simulated signals from the first and second emitters, according to an embodiment. The centers of antennae 630a and 630b are separated by distance L 632. The first emitter with spectrum 613 arrives in a first direction at angle θ₁ from the bore site direction 631 of the antennae. Each wavefront arrives at successive antennae after traveling a distance d₁=L sin(θ₁) 640a that corresponds to a time delay of τ₁=d₁/c, where c is the speed of light. Similarly, the second emitter with spectrum 623 arrives in a second direction at angle θ₂ from the bore site direction 631 of the antennae, with each wavefront arriving at successive antennae after traveling a distance d₂=L sin(θ₂) 640b that corresponds to a time delay of τ₂=d₂/c.

The voltage signals V1(t) 644a simulated for antenna 630a and V2(t) 644b simulated for antenna 630b are used at corresponding drives of a MZI FIG. 6D is a block diagram that illustrates an example apparatus for determining simultaneously the spectra that indicate the angles of arrival for signals from both emitters, according to an embodiment. The apparatus includes a MZI 610 configured for a phase shift of φ_{MZ}, in which an optical carrier 652 is split into two paths. One path is driven at optical modulator 654 by the signal V1(t) 644a of antenna 630a, and the other path is driven at optical modulator 655 by the signal V2(t) 644b of antenna 630b.

The beam emerging from Port A 664a of the MZI 610 is recorded at one spectrum analyzer 670a after which a probe signal 672a produces readout 674a. Similarly, the beam emerging from Port B 664b of the MZI 610 is recorded at another spectrum analyzer 670b after which a probe signal 672b produces readout 674b. In some embodiments, the spectrum analyzers 670a and 670b are two different portions of a single crystal of an SSH material.

FIG. 7 is a diagram that illustrates example spectra from both ports of a dual-drive, dual-port MZI at each of several processing steps, according to an embodiment. Each spectrum is displayed on the same horizontal axis 702 of frequency in GHz from the optical carrier frequency, and the same power density vertical axis 704, separated by vertical offsets for clarity.

A hypothetical target power spectrum of the first emitter, were it modulated onto the optical carrier, is shown as trace 710. The first emitter power spectrum 613 is shown as an upper sideband above the optical carrier peak at 0 GHz; and, a reflected version of the first spectrum 613 is shown as a lower sideband below the optical carrier peak at 0 GHz. The interference of this spectrum with a τ₁ delayed version of itself in the MZI is shown at output port A and Port B of the MZI. Trace 720 shows the first emitter frequency response at Port A due to the geometry of the arrival angle and is based on the L sin(θ₁) dependence illustrated in FIG. 6C. On the same vertical axis, the product of the frequency response with the first emitter spectrum 710 modulated on the optical carrier is shown as trace 722, the spectrum of emitter 1 at Port A. On the next vertically offset axis, trace 730 shows the first emitter frequency response at Port B due to the geometry of the arrival angle and is based on a complement of the L sin(θ₁) dependence illustrated in FIG. 6C. On the same vertical axis, the product of the frequency response with the first emitter spectrum 710 modulated on the optical carrier is shown as trace 732, the spectrum of emitter 1 at Port B.

Similarly, a hypothetical target spectrum of the second emitter, were it modulated onto the optical carrier, is shown as trace 740. The first emitter spectrum 623 is shown as an upper sideband above the optical carrier peak at 0 GHz; and, a reflected version of the second spectrum 623 is shown as a lower sideband below the optical carrier peak at 0 GHz. The interference of this spectrum with a τ₂ delayed version itself in the MZI is shown at output port A and Port B of the MZI. Trace 750 shows the first emitter frequency response at Port A due to the geometry of the arrival angle and is based on the L sin(η₂) dependence illustrated in FIG. 6C. On the same vertical axis, the product of the frequency response with the second emitter spectrum 740 modulated on the optical carrier is shown as trace 752, the spectrum of emitter 2 at Port A. On the next vertically offset axis, trace 760 shows the first emitter frequency response at Port B due to the geometry of the arrival angle and is based a complement of the L sin(η₂) dependence illustrated in FIG. 6C. On the same vertical axis, the product of the frequency response with the second emitter spectrum 720 modulated on the optical carrier is shown as trace 762, the spectrum of emitter 2 at Port B.

Since both emitters arrive at the antennae, the ideal measured spectrum at each port is given by the sum of the spectra of the first and second emitters at that port. Thus, trace 770 depicts the modulated spectrum of both emitters at Port A. Trace 772 depicts the modulated spectrum of both emitters at Port B. The actual measured spectra closely resemble the ideal.

The post processing calls for determining the sum and difference of the spectra at the two ports. Trace 780 indicates the difference of trace 770 at Port A and trace 772 at Port B, and is related to the phase difference at the two antennae, from which the angles of arrival can be determined for both emitters. Trace 782 indicates the sum of the spectra of trace 770 at Port A and trace 772 at Port B, and represents the total signal spectra from the two emitters received by the two antennae, from which the power can be determined for both emitters. Assuming negligible loss at the antennae or equipment, the spectrum 782 is substantively equal to the sum of the hypothetical spectra 710 and 740.

FIG. 7B is a diagram that illustrates example measured frequency dependent phase and time delay derived from the difference and sum of the spectra from both ports of a dual-drive, dual-port MZI at each of several processing steps, according to an embodiment. Each trace is displayed on the same horizontal axis 792 of frequency in GHz relative to the optical carrier frequency. Plot 797 shows a trace of the measured phase φ using Equation 10b, based on the inverse sine of the ratio of measured difference trace (representing trace 780) to the measured sum trace (representing trace 782). Vertical axis 795 indicates the phase in arbitrary units. Plot 799 shows a trace of the measured delay tin picoseconds using Equation 10c, by dividing the phase of plot 797 by the angular frequency corresponding to each frequency position on axis 792. Vertical axis 796 indicates the measured delay in picoseconds.

The optical carrier shows a delay of 0 ps at a frequency of 0 relative to the optical carrier, as expected. As can be seen, some frequencies produce a measured delay of about 8 ps, while other frequencies produce a measured delay of about −18 ps. Cleary two different emitters producing RF waves that arrive at two different angles are indicated. The spectrum of trace 782 can easily be separated into spectra 710 and 740 based on the different delays (with corresponding different angles of arrival). The spectra 613 and 623 can easily be derived from the spectra of trace 710 and trace 740, respectively.

### Dual-Port Partial-Band Processing

Both the dual sideband with single port and dual sideband with dual port configurations have operational limitations when operating on wideband RF signals. In some embodiment for direction finding with wideband RF signals, a modified architecture is used. As in the above architectures, a phase sensitive photonic signal processing device is utilized based on spatial spectral (S2) holographic materials. The RF signals or waveforms of interest, typically from two or more antennae, are up-converted onto an optical carrier via an optical modulator, and the signals from each pair of antennae are interferometrically mixed in a Mach Zender interferometer (MZI).

In the embodiments described in this section, the elements are as follows. The MZI is configured so that there are two output ports. Light beams of both output ports of the MZI are made to irradiate corresponding volumes of S2 material. Readout occurs for each irradiated volume but with a chirp limited in bandwidth to span a single sideband, where one readout corresponds to, and is used as, the signal that was previously described as the lower sideband, and the other readout corresponds to, and is used as, the signal that was previously described as the upper sideband.

An illustrated embodiment of the invention builds on the fact that in Eq. (1), it can be seen that at certain interferometric bias conditions, φ_{MZ}=±π/2, referred to as quadrature processing of the MZI, the sidebands in the output of one port are identical to the opposite sidebands in the output of the other. This allows a simpler readout process with more limited bandwidth and different post processing. Thus, in the illustrated embodiments, only one sideband in each of both output ports of the MZI are utilized and the upper (or lower) sidebands of each port are read out and recorded in the S2 material independently.

This solution has the following features. There is a single optical carrier used in the MZI. Both output ports of the MZI are used for recording, but in the most straightforward implementation only the upper sideband (or only lower sideband) from each of both ports is recorded and readout. Two spatial volumes are utilized in the recording material, one for each port of the MZI. Each volume of the recording material is readout, but with half of the readout bandwidth, or less. The information from each volume is used in the post processing methods, one in place of the previously described “upper sideband” and one in place of the previously described “lower sideband”.

From Equation 8 the lower sideband on Port 1 and upper sideband on Port 2 are given. If the two ports are used and only the upper sidebands are read out, a different ratio can be taken as Equation 14

$${S}_{+}^{( k )} = \frac{{P}_{1 +}^{( k )} ( v ) - {P}_{2 +}^{( k )} ( v )}{{P}_{1 +}^{( k )} ( v ) + {P}_{2 +}^{( k )} ( v )} = \frac{2 η}{1 + {η}^{2}} cos ( v {τ}_{k} - {φ}_{MZ} ) . \qquad ( 14 )$$

This ratio can be used to estimate time delays provided the contrast and bias are known. At quadrature operation, where φ_{MZ}=+π/2, the ratio is given by Equation 15.

$${S}_{+}^{( k )} = \frac{2 η}{1 + {η}^{2}} sin ( v {τ}_{k} ) \qquad ( 15 )$$

which is the same ratio as equation (3) above at quadrature, since P₁₋ and P₂₊ are identical at quadrature. The ratio at quadrature can be used to estimate time delays provided the contrast is known. Similarly P₁₊ and P₂₋ are identical at quadrature, so similar processing could be done if only the lower sidebands are read out.

$${S}_{-}^{( k )} = \frac{{P}_{2 -}^{( k )} ( v ) - {P}_{1 -}^{( k )} ( v )}{{P}_{2 -}^{( k )} ( v ) - {P}_{1 -}^{( k )} ( v )} \qquad ( 16 )$$

Also, similar results are obtained if the MZ is held at quadrature with φ_{MZ}=−π/2 in both cases presented above.

Thus an advantage of these embodiments is that it is sufficient to readout just one (either upper or lower) sideband on each port in the same frequency range. The sidebands are recorded in separate recording volumes, e.g., portion 222a and portion 222b.

FIG. 8 is a block diagram that illustrates the relationships of the readout windows required for a single or dual-port operation and an example bandwidths of an SSH material compared to output from both ports of a dual-drive, dual-port MZI, according to an embodiment. This embodiment is demonstrated with reference to the simulated example described above with reference to FIG. 6A, FIG. 6B, FIG. 6C. Each spectrum is displayed on the same horizontal axis 802 of frequency in GHz from the optical carrier frequency, and the same power density vertical axis 804, separated vertically for clarity. The trace 770, described above with reference to FIG. 7, represents the total spectrum at Port A. Similarly, trace 772, described above with reference to FIG. 7, represents the total spectrum at Port B. The RF band of interest 840 is also shown below axis 802, where the value for 840 is defined by the frequency content of the RF signals received by the antennae, along with the maximum frequency 850 of the first emitter signals and the maximum frequency 852 of the second emitter signals. In the example emitter spectra, the maximum frequency 850 of the first emitter is the maximum frequency within the RF band of interest 840.

The dual sideband recording bandwidth 810 required to be read out from the device according to the above methods for using both sidebands of one or both ports is much wider than the single sideband recording bandwidth 820 required to be read out according to the methods for using only one sideband from both ports. In this example, only the upper sideband is readout and the chirp bandwidth need only be the bandwidth 820. An advantage of this approach is that for very wideband RF signals of interest, the inhomogeneously broadened absorption bandwidth 830 of a particular SSH material may not be sufficient to span both sidebands. Even in the case that the absorption bandwidth 830 is sufficient, an advantage of the approach is that one readout laser spanning a particular bandwidth (e.g., 20 GHz) can be used and the light split into two paths, rather than requiring a readout laser of twice that bandwidth (e.g., 40 GHz) or two readout lasers of the same bandwidth (e.g., 20 GHz) with different frequency spans.

Thus, in some embodiments, the frequency swept optical beam extends over a band width 810 that is substantively equal to double a greater frequency 850 of a maximum frequency of interest 850 of the first radio frequency signal and a maximum frequency of interest 852 of the second radio frequency signal. In such embodiments, the spectral spatial grating has an inhomogeneously broadened absorption spectrum bandwidth that is at least as wide as double the greater frequency 850 of the maximum frequency of interest of the first radio frequency signal and the maximum frequency of interest of the second radio frequency signal.

In other embodiments, the frequency swept optical beam extends over a band width 820 that is wider than a frequency band of interest 840 in the first radio frequency signal and much less wide than a maximum frequency of interest 850 of the first radio frequency signal or a maximum frequency of interest 852 of the second radio frequency signal. In some of these embodiments, the spectral spatial grating has an inhomogeneously broadened absorption spectrum bandwidth 830 that is at least as wide as the frequency band of interest 840 in the first radio frequency signal.

For example, one could record and readout Port A upper sideband (USB-A) and Port B upper sideband (USB-A), both with a chirp with the reduced bandwidth 820, or could record and readout Port A lower sideband (LSB-A) and Port B lower sideband (LSB-B) with the reduced bandwidth (displaced to lower optical frequencies). The optical readout chirp, e.g., readout probe 672a and readout probe 672b in FIG. 6D, reads out only one sideband in the same frequency range from each volume. For example, using chirp with bandwidth 820, the lower sidebands LSB-A and LSB-B are ignored. From this point, each readout signal can be used for post-processing, as described above, to estimate relative time delays and angles of arrival.

In this configuration the spectral information can be recorded closer to the center of the material absorption band 830. The chirp and material bandwidth can now better be matched to the full operational bandwidth of the detection operation. It should be noted that the MZI in this case is slightly more sensitive to a quadrature bias point operation than for the single port, dual sideband configuration described above and significantly more sensitive to contrast than for the dual port configuration described above. Embodiments were implemented, for example as expressed in the following examples.

FIG. 9A is a graph that illustrates the determination of delay from the simulated signals, showing where each was measured simultaneously from both emitters and reduced readout bandwidth, according to an embodiment. Each trace is displayed on the same horizontal axis 802 of frequency in GHz from the optical carrier frequency. Note that axis 902 spans only the upper sideband, e.g. frequencies at and above the optical carrier frequency at 0 GHz. Each spectrum is displayed on the same power density vertical axis 904, separated vertically for clarity. Trace 910 shows the USB-A of trace 770; and trace 920 shows the USB-B of trace 772.

Trace 930 shows the measured phase φ using Equation 15. Vertical axis 905 indicates the phase in arbitrary units. Trace 940 shows the measured delay τ in picoseconds using Equation 10c. Vertical axis 906 indicates the measured delay in picoseconds.

The optical carrier shows a delay of 0 ps at a frequency of 0 relative to the optical carrier, as expected. As can be seen, some frequencies produce a measured delay of about 8 ps, while other frequencies produce a measured delay of about −18 ps. Cleary two different emitters producing RF waves that arrive at two different angles are indicated. The spectrum of trace 920 can easily be separated into spectra 613 and 623 based on the different delays (with corresponding different angles of arrival).

In other embodiments, the readout bandwidth 820 only spans the RF frequency band of interest and does not include the optical carrier at 0 GHz. In some of these embodiments, a reference peak within the band of interest is added to both MZI paths to properly align the chosen sideband of the two MZI output ports.

### More Experimental Data, Single Port, Dual Sideband Programming and Readout Operation

FIG. 9B is a graph of experimental data that illustrates the determination of angle of arrival history measured simultaneously from two RF path, one with a fixed delay and one with adjustable delay, and reduced readout bandwidth, according to an embodiment. The determination distinguishes a stationary emitter given by trace 961 from a moving emitter 962. This demonstration was done with spectral content between 4-8 GHz, where a single readout laser spanning over 16 GHz was used, and where both sidebands (the USB and LSB) from one port of the MZI were recorded and read out. The graph shows two (2) frequencies with non-negligible power, when in fact for this demonstration about 10,000 tones could have been tracked with 0.4 MHz resolution over 4 GHz. The relatively stationary signal (ideally fully stationary) was a single frequency tone at near 4.5 GHz. The moving signal was a wideband signal of about 0.5 GHz in bandwidth that was moving in the sense that it was emulated by having that wideband RF signal pass through a mechanical RF delay line that was manually adjusted by a person's hand during the duration of the display. For an estimate in the experimental error in the angle of arrival of this display, one can observe a ˜1-2 degrees accuracy for the fixed delay, and better for the moving signal due to averaging over the signal bandwidth.

FIG. 9C is a graph that illustrates example time delay error experimental results for single shot data, where the accuracy is better than demonstrated in FIG. 9B, according to an embodiment. The experimental apparatus had a mechanical delay line with a calibrated delay that was read by a micrometer setting in one of the paths, and the accuracy was measured for single shot data for a single frequency at 5.962 GHz that was part of a wideband signal spanning a bandwidth of about 0.5 GHz. The horizontal axis 982 is delay in picoseconds; and the vertical axis 984 is error in picoseconds. Each bar 986 indicates a difference between the actual delay and the delay computed using the MZI and SSH apparatus and Equation 15. In this demonstrated embodiment, the delay error was about 1 ps or less for delays from −50 ps to +50 ps. Performance better than this is anticipated in other embodiments.

### Methods

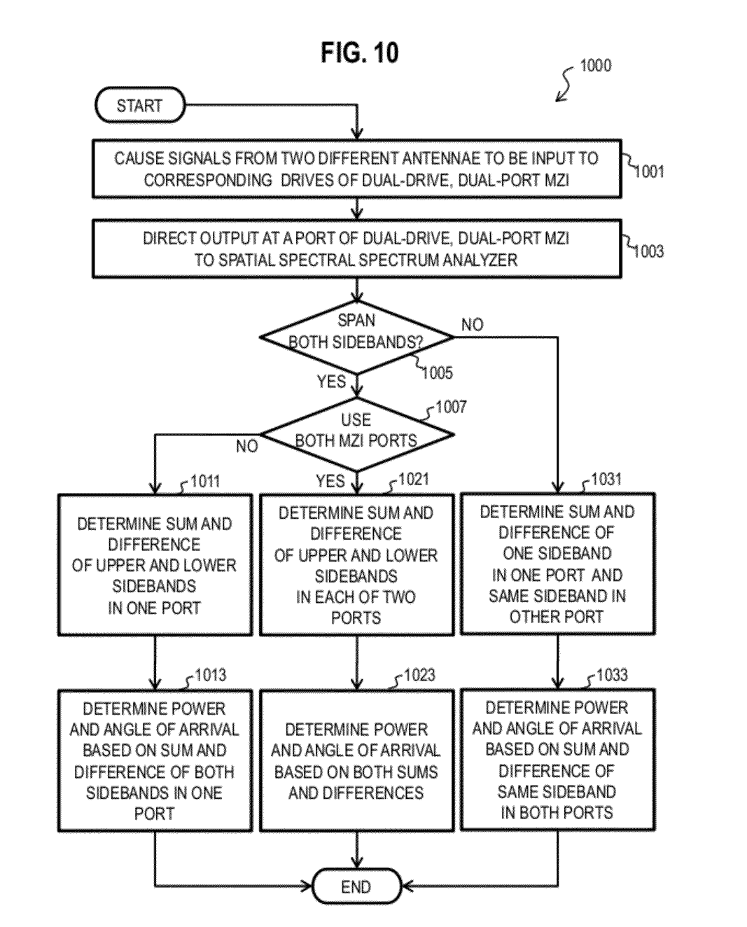

FIG. 10 is a flow chart that illustrates at a high level an example method 1000 for using a dual-drive, dual-port MZI and optical spectral analyzer to determine angle of arrival history, according to various embodiments. Although method 1000 is depicted with integral steps in a particular arrangement for purposes of illustration, in other embodiments, one or more steps, or portions thereof, are performed in a different order or overlapping in time, in series or in parallel, or are omitted or one or more additional steps are added.

In step 1001, signals from two different sources, such as two different antennae in an antennae array, are input into corresponding drives of a dual-drive, Mach-Zehnder interferometer (MZI). In some embodiments, the MZI is configured with a known attenuation or phase (such as quadrature) to use with single sideband readout and post processing. In some embodiments, the MZI is configured with only a single output port. In some embodiments, the MZI is a dual-port MZI configured with two output ports.

In step 1003, output at one or more ports of the dual-drive, dual-port MZI is directed to a spectral analyzer, such as the one indicated being a spectrum analyzer based on an SSH material, as described above, or others known in the art with sufficient bandwidth and frequency resolution such as listed above.

In step 1005, it is determined whether both sidebands are to be used. If so, then control passes to step 1007. Otherwise control passes to step 1031 to process a single sideband from multiple ports. In some embodiments, the number of sidebands is fixed; step 1005 is omitted; and control passes directly to step 1031 for single sideband processing, or to step 1007 for multiple sideband processing.

If it is determined that both sidebands are to be used, control passes to step 1007 to determine how many of the MZI output ports are to be used, one or both. If it is determined in step 1007 that only one port is to be used, then control passes to steps 1011 and 1013. In some embodiments, the number of ports is fixed; step 1007 is omitted; and control passes directly to step 1011 for single port processing, or to step 1021 for multiple port processing.

In step 1011, the sum and difference of the upper and lower sidebands of a single MZI output port are determined. For example, trace 770 or 772 is determined. In step 1013, the spectral power and angle of arrival are determined for each frequency bin. For example, based on the sum, the spectral power is determined using Equation 9 and the upper and lower sidebands of one port. Based on a ratio of the difference to the sum in the upper and lower sidebands, respectively, and Equations 10a and 10c, the phase and delay are determined for each frequency. The angle of arrival is determined based on the delay and antenna spacing.

If it is determined in step 1007 that both ports are to be used, then control passes to steps 1021 and 1023. In step 1021, the sum and difference of the upper and lower sidebands of both MZI output ports are determined. For example, traces 780 and 782 are determined. In step 1013, the spectral power and angle of arrival are determined for each frequency bin. For example based on the sum the spectral power is determined. Based on a ratio of the difference to the sum in traces 780 and 782, respectively, and Equations 13, the phase and delay are determined for each frequency. The angle of arrival is determined based on the delay and antenna spacing.

If it is determined, in step 1005, that both sidebands are not to be used, then control passes to step 1031 to process a single sideband from multiple ports. In step 1031 the sum and difference of the same sideband in different ports are determined. For example, traces 920 and 910, respectively, for the upper sideband only are determined. In step 1033, the spectral power and angle of arrival are determined for each frequency bin. For example based on the sum the spectral power is determined. Based on a ratio of the difference to the sum in traces 910 and 920, respectively, and Equations 15, the phase and delay are determined for each frequency. The angle of arrival is determined based on the delay and antenna spacing.

As described herein, in various embodiments, a Mach-Zehnder Interferometer (MZI) with two input ports and one or two output ports is implemented. The MZI has a 2×2 input coupler that couples the two input ports and a 2×2 output coupler that generates two output ports.

In some embodiments this MZI is implemented on a monolithic structure and in other embodiments it has optical fibers and fiber couplers. Each path of the MZI has a modulator that can modulate the phase of the optical carrier.

In some embodiments the RF signals are modulated onto a stable laser optical carrier by means of an electro-optic phase modulator (EOM). The EOM creates a double sideband optical signal along with the carrier, where the information about the RF signal is encoded in both the upper sideband (USB) and lower sideband (LSB).

In some embodiments, the generated RF waveforms are described as being wide bandwidth waveforms with arbitrary modulation format and spectral content. The RF waveform pair that drives the EOM is identical and time delayed. In some embodiments the time delay is shorter than the duration of the RF waveform

In some embodiments, one can adjust any of these RF waveform parameters as determined by the user and/or hardware specifications.

In some embodiments the MZI is configured to operate in quadrature and in a stable mode by actively measuring and canceling the phase and intensity fluctuations.

In some embodiments the outputs of the MZI are analyzed with spatial-spectral spectrum analyzer using rare-earth doped crystals, referred to as S2 materials. The amplitude and phase of each the USB and LSB on the 2 output ports of the MZI are recorded in the S2 materials at 2 different spots.

In some embodiments, both upper sidebands in the two spots are used for recording and analysis.

In some embodiments, both lower sidebands in the two spots are used for recording and analysis.

In some embodiments, both upper and lower sidebands in the two spots are used for recording and analysis.

In some embodiments the spectral information recorded in the S2 material is readout by an optical frequency chirp. The resultant signal is detected with an optical detector and digitized. The distortions due to fast scan are eliminated by spectral recovery.

In some embodiments, the sum and difference of the sidebands yield the power and phase spectrum of the RF waveforms respectively.

In some embodiments, a ratio of the difference to the sum of the sidebands yields the parameter that can be used to extract the desired phase information.

In some embodiments, the architecture can be extended to multiple antenna outputs, implying multiple RF drives, and multiple interferometric paths, implying multiple ports, by implementing pairwise or other combinations of drives and ports that can be constructed from single or dual-port, dual-drive MZI configurations.

### Post Processing Equipment

The processes described herein for providing post processing the digital signals may be advantageously implemented via software, hardware, firmware or a combination of software and/or firmware and/or hardware. For example, the processes described herein may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

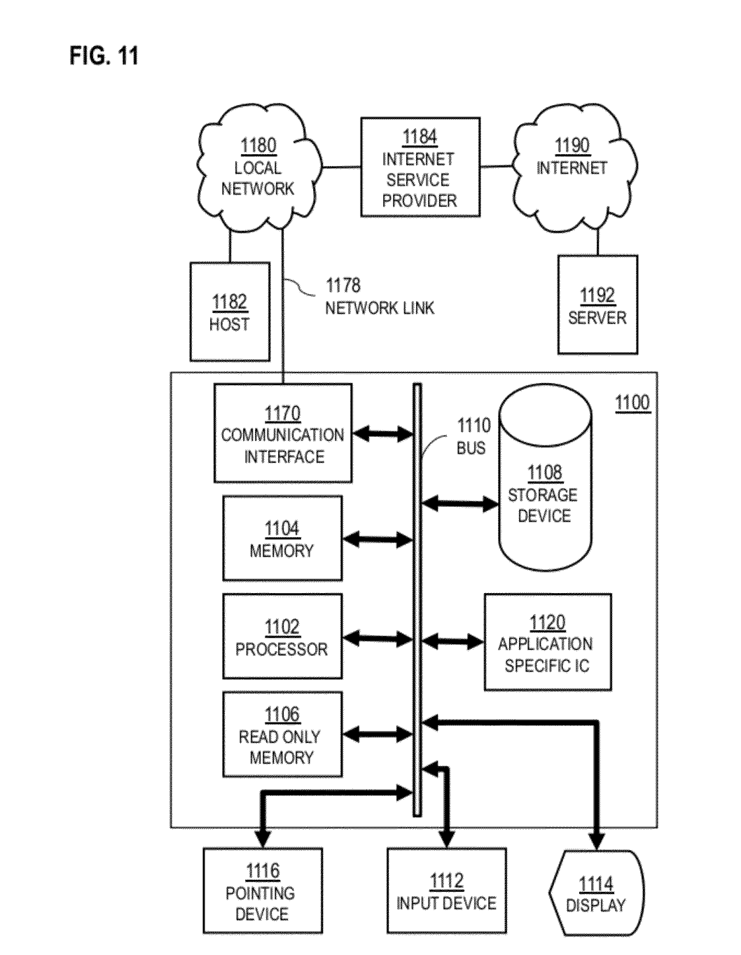

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to post process the digital signals as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of post processing.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to post processing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or other dynamic storage device, stores information including processor instructions for post processing. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for post-processing, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communications interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communications interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communications interface 1170 may be a local area network (LAN) card to provide a data communication connection to a compatible LAN, such as Ethernet. Wireless links may also be implemented. For wireless links, the communications interface 1170 sends or receives or both sends and receives electrical, acoustic or electromagnetic signals, including infrared and optical signals, that carry information streams, such as digital data. For example, in wireless handheld devices, such as mobile telephones like cell phones, the communications interface 1170 includes a radio band electromagnetic transmitter and receiver called a radio transceiver.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement various embodiments. Thus, embodiments of the invention are not limited to any specific combination of hardware and software, unless otherwise explicitly stated herein.

The signals transmitted over network link 1178 and other networks through communications interface 1170, carry information to and from computer system 1100. Computer system 1100 can send and receive information, including program code, through the networks 1180, 1190 among others, through network link 1178 and communications interface 1170. In an example using the Internet 1190, a server host 1192 transmits program code for a particular application, requested by a message sent from computer 1100, through Internet 1190, ISP equipment 1184, local network 1180 and communications interface 1170. The received code may be executed by processor 1102 as it is received, or may be stored in memory 1104 or in storage device 1108 or other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infra-red carrier wave serving as the network link 1178. An infrared detector serving as communications interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

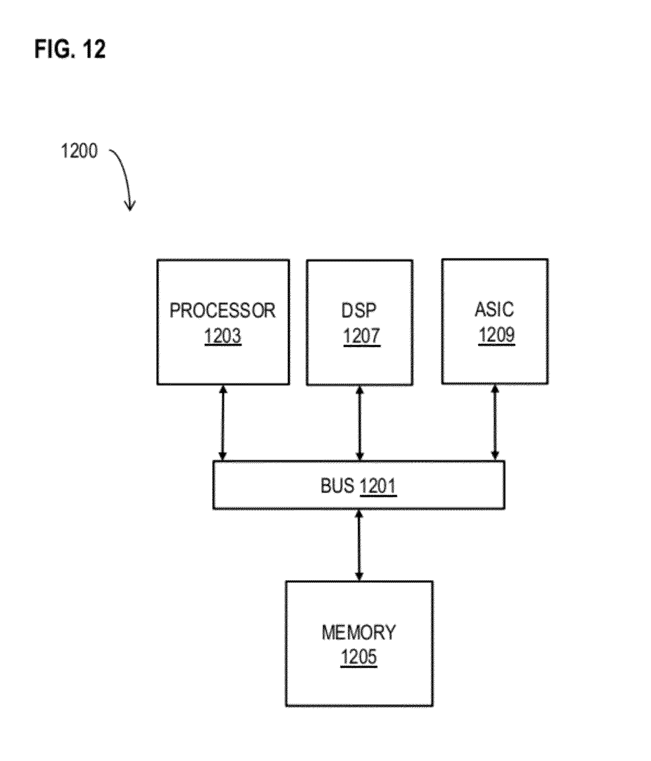

FIG. 12 illustrates a chip set or chip 1200 upon which an embodiment of the invention may be implemented. Chip set 1200 is programmed for post-processing as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of services. Chip set or chip 1200, or a portion thereof, constitutes a means for performing one or more post processing steps.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein. The memory 1205 also stores the data associated with or generated by the execution of the inventive steps.

### Alternatives and Modifications

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items. elements or steps. Furthermore, the indefinite article “a” or “an” is meant to indicate one or more of the item, element or step modified by the article.

### REFERENCES

The following publications are hereby incorporated by reference as if fully set forth herein, except in so far as the terminology is inconsistent with the terminology used herein.
i) T. Chang, R. K. Mohan, M. Tian, T. L. Harris, W. R. Babbitt, K. D. Merkel, Frequency-chirped readout of spatial-spectral absorption features, Physical Review A 70, 063803 (2004)
ii) T. Chang, R. Krishna Mohan, T. L. Harris, M. Tian, W. R. Babbitt, and K. D. Merkel, “Frequency chirped readout of spectral absorption features: Bridging the gap between absorption spectroscopy and coherent transient spectroscopy”, Phys. Rev. A 70, 063803 (2004).
iii) T. Chang, M. Tian, R. Krishna Mohan, C. Renner, K. D. Merkel, and W. R. Babbitt, “Recovery of spectral features readout with frequency-chirped laser fields”, Opt. Lett., 30, 1129-1131, (2005)
iv) K. D. Merkel, R. Krishna Mohan, Z. Cole, T. Chang, A. V. Olson and W. R. Babbitt, “Multi-Gigahertz Radar Range Processing of Baseband and Modulated RF carrier Signals in Tm:YAG”, J. Lum. 107 62-74 (2004).
v) T. L. Harris, K. D. Merkel, R. K. Mohan, T. Chang, Z. Cole, A. Olson, and W. R. Babbitt, “Multigigahertz range-Doppler correlative signal processing in optical memory crystals,” Applied Optics, 45(2), 343-352 (2006).
vi) M. Shirasaki, “Large angular dispersion by a virtually imaged phased array and its application to a wavelength demultiplexer,” Optics letters, vol. 21, no. 5, pp. 366-368, 1996.
vii) B. Szafraniec et al., “Swept Coherent Optical Spectrum Analysis,” IEEE Transactions on Instrumentation and Measurement, vol. 53, pp. 203-215, 2004.
viii) V. Crozatier, G. Gorju, J. Legouet, F. Bretenaker, and I. Lorgere, “Photon echo chirp transform using a stabilized frequency agile laser,” Journal of Luminescence, vol. 127, no. 1, pp. 104-109, November 2007; L. Ménager, I. Lorgeré, J. L. Le Gouët, D. Dolfi, and J. P. Huignard, “Demonstration of a radio-frequency spectrum analyzer based on spectral hole burning,” Optics Letters, vol. 26, no. 16, pp. 1245-1247, 2001.

What is claimed is:

1. An apparatus comprising:
a dual-drive Mach-Zehnder Interferometer configured to generate at one path a first optical signal, and to generate at a different path a second optical signal; and
an optical spectrum analyzer configured to receive output from at least one port of the dual-drive Mach-Zehnder Interferometer.

2. An apparatus as recited in claim 1, wherein the optical spectrum analyzer comprises a spatial-spectral spectrum analyzer configured to form a spectral grating based on optical output received from at least one port of the dual-drive Mach-Zehnder Interferometer.

3. An apparatus as recited in claim 2, wherein the optical spectrum analyzer further comprises an optical source configured to probe the spectral grating with a frequency swept optical beam.

4. An apparatus as recited in claim 3, wherein the optical spectrum analyzer further comprises an optical detector configured to detect an output from the spatial-spectral spectrum analyzer in response to the frequency swept optical beam.

5. An apparatus as recited in claim 1, wherein:
the first optical signal is a first optical carrier modulated by a first radio frequency signal; and
the second optical signal is a second optical carrier modulated by a second radio frequency signal.

6. An apparatus as recited in claim 5, wherein:
the first radio frequency signal is based on a radio frequency output from a first antenna; and
the second radio frequency signal is based on a radio frequency output from a different second antenna.

7. An apparatus as recited in claim 5, wherein an optical frequency content of the first optical carrier is substantively identical to an optical frequency content of the second optical carrier.

8. An apparatus as recited in claim 3, wherein:
the first optical signal is a first optical carrier modulated by a first radio frequency signal; and
the second optical signal is the first optical carrier modulated by a second radio frequency signal.

9. An apparatus as recited in claim 8, wherein the frequency swept optical beam extends over a band width that is substantively equal to double a greater frequency of a maximum frequency of interest of the first radio frequency signal and a maximum frequency of interest of the second radio frequency signal.

10. An apparatus as recited in claim 9, wherein the spectral spatial grating has an inhomogeneously broadened absorption spectrum bandwidth that is at least as wide as double the greater frequency of the maximum frequency of interest of the first radio frequency signal and the maximum frequency of interest of the second radio frequency signal.

11. An apparatus as recited in claim 8, wherein:
the spatial-spectral spectrum analyzer is configured to form two separate spectral gratings based on optical output generated from two ports of the dual-drive Mach-Zehnder Interferometer;
the optical source is configured to probe the two separate spectral gratings with the frequency swept optical beam; and
the frequency swept optical beam extends over a band width that is wider than a frequency band of interest in the first radio frequency signal and much less wide than a maximum frequency of interest of the first radio frequency signal or a maximum frequency of interest of the second radio frequency signal.

12. An apparatus as recited in claim 11, wherein the spectral spatial grating has an inhomogeneously broadened absorption spectrum bandwidth that is at least as wide as the frequency band of interest in the first radio frequency signal.

13. An apparatus as recited in claim 6, further comprising a processor configured to determine arrival angle at each of a plurality of frequencies in the frequency band of interest in the first radio frequency signal based on output from the optical spectrum analyzer.

14. An apparatus as recited in claim 13, wherein to determine arrival angle further comprises to determine a delay and a power based on a sum and difference of both sidebands from the optical spectrum analyzer for one output port of the dual-drive Mach-Zehnder Interferometer.

15. An apparatus as recited in claim 13, wherein to determine arrival angle further comprises to determine a delay and a power based on a sum and difference of both sidebands from the optical spectrum analyzer for each of two output ports of the dual-drive Mach-Zehnder Interferometer.

16. An apparatus as recited in claim 13, wherein to determine arrival angle further comprises to determine a delay and a power based on a sum and difference of one sideband from the optical spectrum analyzer for each of two output ports of the dual-drive Mach-Zehnder Interferometer.

17. A method comprising:
causing radio frequency signals from two different antennae to modulate an optical carrier at a corresponding drive of a dual-drive Mach-Zehnder Interferometer;
causing output from at least one port of the dual-drive Mach-Zehnder Interferometer to be directed to an optical spectrum analyzer; and
determining arrival angle at each of a plurality of frequencies in the radio frequency signals based on output from the optical spectrum analyzer.

18. A method as recited in claim 17, wherein determining arrival angle further comprises determining a sum and a difference of upper and lower sideband spectra from the optical spectrum analyzer for the at least one port of the dual-drive Mach-Zehnder Interferometer.

19. A method as recited in claim 17, wherein:
causing output from at least one port of the dual-drive Mach-Zehnder Interferometer to be directed to the optical spectrum analyzer further comprises causing output from both ports of the Mach-Zehnder Interferometer to be directed to an optical spectrum analyzer; and
determining arrival angle further comprises determining a sum and a difference of two spectra, each spectrum representing the same sideband from the optical spectrum analyzer for a corresponding port of the Mach-Zehnder Interferometer.

20. A non-transitory computer-readable medium carrying one or more sequences of instructions, wherein execution of the one or more sequences of instructions by one or more processors causes an apparatus to perform the step of:
determining arrival angle at each of a plurality of frequencies in radio frequency signals based on output data from an optical spectrum analyzer that records spectra for signals from at least one port of a dual-drive Mach-Zehnder Interferometer,
wherein each drive of the dual-drive Mach-Zehnder Interferometer is driven by an optical carrier modulated by the radio frequency signal from a corresponding different antennae.

21. An apparatus comprising:
at least one processor; and
at least one memory including computer program code for one or more programs,
the at least one memory and the computer program code configured to, with the at least one processor, cause the apparatus to perform at least the following,
determining arrival angle at each of a plurality of frequencies in radio frequency signals based on output data from an optical spectrum analyzer that records spectra for signals from at least one port of a dual-drive Mach-Zehnder Interferometer,
wherein each drive of the dual-drive Mach-Zehnder Interferometer is driven by an optical carrier modulated by the radio frequency signal from a corresponding different antennae.

22. An apparatus comprising:
means for determining a sum and a difference of two spectra, each spectrum representing at least one sideband from an optical spectrum analyzer for a corresponding port of a dual-drive Mach-Zehnder Interferometer; and
means for determining arrival angle at each of a plurality of frequencies in radio frequency signals based on the sum and the difference,
wherein each drive of the dual-drive Mach-Zehnder Interferometer is driven by an optical carrier modulated by the radio frequency signal from a corresponding different antennae.
